(19) United States
(12) Patent Application Publication
(10) Pub. No.: US 2022/0332164 A1
(43) Pub. Date: Oct. 20, 2022

(54) SYSTEM FOR CONTROLLING THE TEMPERATURE OF A BATTERY IN A VEHICLE AND FOR DEFROSTING A RADIATOR ASSOCIATED WITH SUCH SYSTEM

(71) Applicant: DENSO THERMAL SYSTEMS S.P.A., Poirino (TO) (IT)

(72) Inventors: Stefano CAGLIERO, Poirino (TO) (IT); Pasquale NAPOLI, Poirino (TO) (IT)

(21) Appl. No.: 17/639,865

(22) PCT Filed: Sep. 1, 2020
(86) PCT No.: PCT/IB2020/058121

§ 371 Date: Mar. 2, 2022

(30) Foreign Application Priority Data
Sep. 2, 2019 (IT) 102019000015376

(51) Int. Cl. B60H 1/00; B60H 1/32; H01M 10/613; H01M 10/615; H01M 10/625; H01M 10/663; H01M 10/6568; H01M 10/6556

(52) U.S. Cl. CPC B60H 1/00278; B60H 1/32284; H01M 10/613; H01M 10/615; H01M 10/625; H01M 10/663; H01M 10/6568; H01M 10/6556; B60H 2001/00961; B60H 2001/00307; H01M 2220/20; B60L 58/24

(57) ABSTRACT

A system includes a battery, and a thermal regulation circuit configured for having liquid pass through and including an operative tract in a thermal exchange relationship with the battery, to control battery temperature. A refrigeration circuit is configured to have pass through that is subjectable to a non-reversible refrigeration cycle. The refrigeration circuit includes a condenser and an evaporator, which are in thermal exchange relation with a heating tract and a cooling tract of the thermal regulation circuit for thermally interacting with the liquid. A radiator is in a thermal exchange relationship with a thermal stabilization tract of the thermal regulation circuit. A valve assembly configured to have a defrosting configuration, in which the valve assembly defines a closed defrosting path for the liquid between the heating tract and the thermal stabilization tract. A heater is activatable to heat the liquid flowing through the closed defrosting path.

### TECHNICAL FIELD

The present invention relates to a system for controlling the temperature of a battery in a vehicle and for defrosting a radiator associated with such system.

### BACKGROUND ART

It is generally known that vehicles are equipped with batteries supplying electric power to devices and apparatuses installed in such vehicles. In particular, in some modern applications, power is also supplied in order to at least partly propel the vehicle, e.g. on electric or “hybrid” vehicles.

In order to ensure the proper operation and a long life of the battery of a vehicle, it is desirable to keep the battery temperature within a given operating range. For example, excessively high operating temperatures may significantly reduce the number of recharging cycles that the battery can be subjected to. Vice versa, excessively low temperatures may reduce the battery performance.

In particular, whenever it is necessary to heat the battery a heat-pump thermal system is employed, wherein an external exchanger is generally used as an evaporator, so that the internal condenser can heat the battery and possibly also the interior or cabin. However, the external evaporator is affected by frost caused by the freezing of the water contained in the air humidity. It is therefore necessary to envisage defrosting cycles for the external exchanger. Nevertheless, the implementation of a defrosting cycle requires a structurally and functionally complex management logic.

### SUMMARY OF THE INVENTION

It is one object of the present invention to provide a system for controlling the temperature of a battery in a vehicle and for defrosting a radiator, wherein such system can solve the problems suffered by the prior art and can be manufactured in a simple and economical manner.

According to the present invention, this and other objects are achieved through a system having the technical features set out in the appended independent claim.

In particular, due to the fact that there is a refrigeration circuit configured for being run through by a fluid that can be subjected to a refrigeration cycle in a non-reversible manner, thermal exchange optimization is possible in this system without using any complex and costly components.

It is understood that the appended claims are an integral part of the technical teachings provided in the following detailed description of the present invention. In particular, the appended dependent claims define some preferred embodiments of the present invention that include some optional technical features.

Further features and advantages of the present invention will become apparent in light of the following detailed description, provided merely as a non-limiting example and referring, in particular, to the annexed drawings as summarized below.

### BRIEF DESCRIPTION OF THE DRAWINGS

FIG. 1 is a functional block diagram representing a system for controlling the temperature of a battery in a vehicle and for defrosting a radiator, wherein such system is made in accordance with an exemplary embodiment of the present invention.

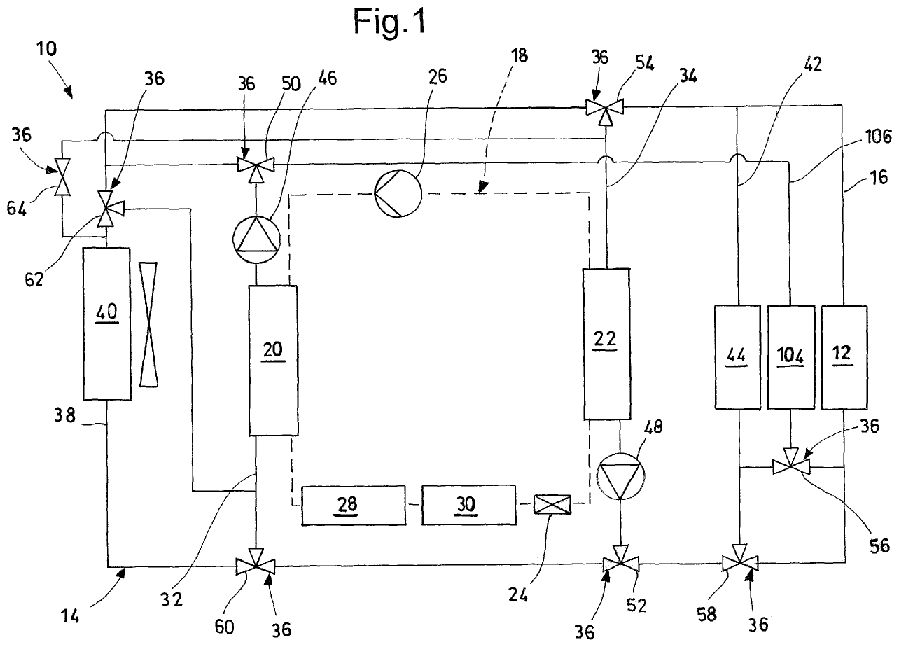

FIG. 2 is a block diagram similar to the one shown in FIG. 1, wherein such system is depicted in a defrosting configuration.

### DETAILED DESCRIPTION OF THE INVENTION

With reference to the annexed drawings, reference numeral 10 designates as a whole a system for controlling the temperature of a battery in a vehicle and for defrosting a radiator associated with such system.

As will be apparent to a person skilled in the art, system 10 may be configured for use in a motor vehicle of any category and type. For example, said motor vehicle may be a motorcar for transporting people or goods, a commercial vehicle, an industrial vehicle, a military vehicle, a building-site vehicle, a sports car, a sport utility vehicle (SUV), an agricultural machine, a train, a bus, etc. Such vehicle may be propelled by means of an internal combustion engine, an electric motor or a “hybrid” propulsion system.

System 10 comprises a battery 12 (or a plurality of batteries) configured for outputting electric power, the temperature of which needs to be controlled, in particular heated or cooled down, according to the operating conditions.

As will be apparent to a person skilled in the art, battery 12 may be any type of battery wherein it is necessary, or desirable, to control the temperature. In particular, battery 12 is configured for supplying electric power to the vehicle on which system 10 is installed. For example, the electric power that the battery can supply may be at least partly used for propelling the vehicle on which the system is installed.

System 10 further comprises a thermal regulation circuit 14, shown in the drawings by means of a continuous line. Thermal regulation circuit 14 is configured for being run through by any liquid, e.g. water, suitable for thermally interacting with battery 12. According to the embodiment illustrated herein, battery 12 is configured for being heated and, respectively, cooled as a function of the operating condition of system 10. However, in other simpler variant embodiments of system 10, it is also conceivable that the battery can only be heated by system 10.

As will be described more in detail below, thermal regulation circuit 14 comprises a plurality of ducts or branches configured to be put in selective communication with one another, so as to define a plurality of paths for the liquid flowing therethrough.

Thermal regulation circuit 14 comprises an operative tract 16 in thermal exchange relation with battery 12, so as to control the temperature thereof. In this manner, the liquid flowing through operative tract 16 can thermally interact with battery 12. In particular, the liquid flowing through operative tract 16 can yield heat to battery 12 or, respectively, receive heat from battery 12, depending on the temperature of the liquid in comparison with that of battery 12.

System 10 further comprises a refrigeration circuit 18, shown in the drawings by means of a dashed line. Refrigeration circuit 18 is configured for being run through by a fluid that can be subjected to a refrigeration cycle in a non-reversible manner and co-operates with thermal regulation circuit 14, as will be described more in detail below.

Refrigeration circuit 18 comprises a condenser 20 and an evaporator 22. In the embodiment illustrated herein by way of example, refrigeration circuit 18 comprises an expansion or lamination valve 24 connected downstream of condenser 20 and upstream of evaporator 22, and a compressor connected downstream of evaporator 22 and upstream of condenser 20.

Preferably, refrigeration circuit 18 further comprises an accumulator 28 connected downstream of the condenser and upstream of the expansion or lamination valve 24. In addition, in the exemplary embodiment illustrated herein the refrigeration circuit comprises a dryer 30 connected downstream of condenser 20 (in particular, in a position situated downstream of accumulator 28) and upstream of expansion or lamination valve 24.

Condenser 20 is in thermal exchange relation with a heating tract 32 of thermal regulation circuit 14, whereas evaporator 22 is in thermal exchange relation with a cooling tract 34 of thermal regulation circuit 14.

Furthermore, thermal regulation circuit 14 comprises a thermal stabilization tract 38 in thermal exchange relation with a radiator 40. For example, radiator 40 may be the radiator of the vehicle on which system 10 is intended to be installed.

System 10 comprises a valve assembly 36 associated with thermal regulation circuit 14. Valve assembly 36 is configured to act upon thermal regulation circuit 14 by taking different operating configurations. For example, the operation of valve assembly 36 can be controlled by a control device or module (not shown) included in system 10 in accordance with predetermined or operator-defined criteria.

In particular, valve assembly 36 is configured for taking at least a heating configuration, with reference to the thermal exchange occurring with battery 12. In the heating configuration, valve assembly 36 defines in thermal regulation circuit 14 a closed heating path for the liquid between operative tract 16 and heating tract 32. At the same time, in the heating configuration valve assembly 36 defines in thermal regulation circuit 14 a further closed cooling path, by connecting together cooling tract 34 and thermal stabilization tract 38. Such closed paths are separate from each other.

Merely by way of example, and with reference to the illustrated embodiment, the following will describe one possible mode of implementation of the closed heating path and also of the closed cooling path.

In particular, said closed heating path comprises heating tract 32, which terminates with a heating valve 50 consisting of, for example, a switching valve. Subsequently, the flow of liquid is diverted from heating tract 32, through heating valve 50, into a further tract numbered as 106. Further, tract 106 terminates with an intermediate valve 56, e.g. a switching valve. The flow of liquid is then directed from tract 106 to operative tract 16 by intermediate valve 56. Subsequently, operative tract 16 terminates into a return valve 54, which diverts the flow into another tract (not numbered), which in turn ends into a recirculation valve 62, e.g. consisting of a switching valve. In its turn, recirculation valve 62 diverts the flow back into tract 32.

Vice versa, the closed cooling path comprises cooling tract 34, which terminates with a cooling valve 52, e.g. a switching valve. Subsequently, the flow of liquid is diverted from cooling tract 34, through cooling valve 52, into a further tract (not numbered), which in turn ends into another recirculation valve 60, e.g. also consisting of a switching valve. The flow of liquid is then diverted, through the other recirculation valve 60, towards thermal stabilization tract 38. Also, the flow of liquid returns into cooling tract 34 through a bypass valve 64, e.g. consisting of a shut-off valve, which allows the fluid to flow through a branch coming from thermal stabilization tract 38 and then into cooling tract 34. The forced circulation of the liquid in the closed heating and cooling paths is made possible by suitable pumping devices 46, 48.

Preferably, thermal regulation circuit 14 comprises an interior heating tract 42 in thermal exchange relation with an air conditioning apparatus 44. In particular, apparatus 44 may be the system for conditioning the air in the interior or cabin of vehicle 10 whereon the system is to be installed. Said apparatus 44 may be any type of HVAC (Heating, Ventilation and Air Conditioning) system.

In the embodiment illustrated herein, interior heating tract 42 is configured to be connected in parallel with operative tract 16, in particular when valve assembly 36 is in the heating configuration.

In this way, in the heating configuration battery 12 is heated and at the same time radiator 40 is cooled and tends to be subject to frosting because of the freezing of the water contained in the air humidity.

Valve assembly 36 is configured for taking a defrosting configuration, in which it defines in thermal regulation circuit 14 a closed defrosting path for the liquid between heating tract 32 and thermal stabilization tract 38.

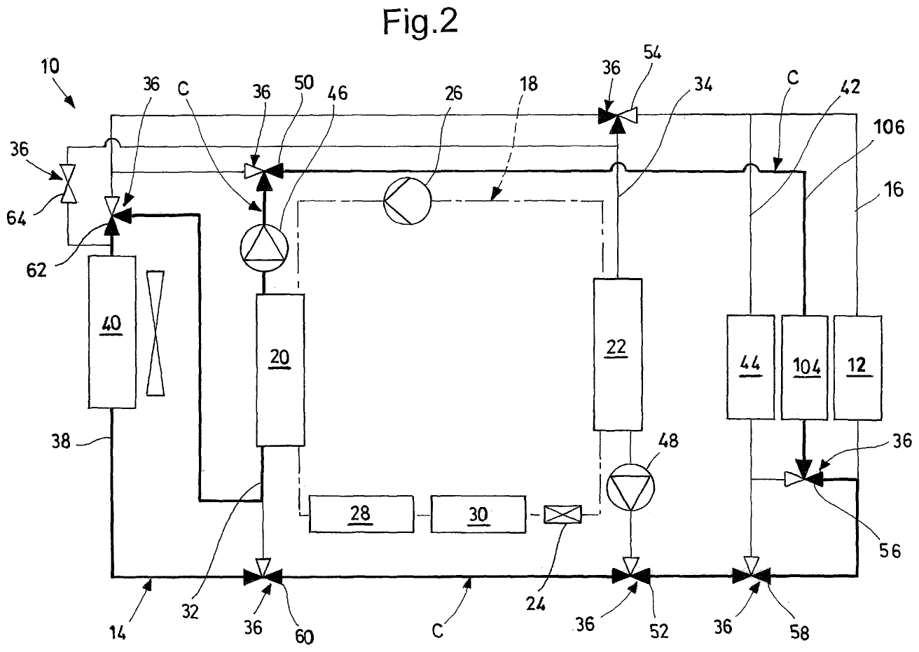

The closed defrosting path, indicated by black arrows designated as C in FIG. 2, is drawn with a bolder line in comparison with the rest of thermal regulation circuit 14. In addition, system 10 comprises a heater 104, which can be activated in the defrosting configuration in order to heat the liquid intended to flow through said closed defrosting path C.

In particular, heater 104 is in thermal exchange relation with a defrosting tract 106 of thermal regulation circuit 14.

In the defrosting configuration, closed defrosting path C for the liquid is defined between heating tract 32, defrosting tract 106 and thermal stabilization tract 38.

In particular, in the defrosting configuration to operative tract 16 is excluded from closed defrosting path C.

In the embodiment illustrated herein, in the defrosting configuration cooling tract 34 is excluded from closed defrosting path C.

For example, valve assembly 36 comprises an intermediate switching valve 56 situated downstream of defrosting tract 106 and upstream of operative tract 16 and of thermal stabilization tract 38.

In the defrosting configuration, intermediate valve 56 directs the liquid flow from defrosting tract 106 to thermal stabilization tract 38, preventing it from passing through operative tract 16.

In particular, system 10 comprises a pumping device 46 configured to induce a forced circulation of the liquid through closed defrosting path C when valve assembly 36 is in the defrosting configuration. Pumping device 46 is preferably situated in heating tract 32.

Advantageously, when valve assembly 36 is in the defrosting configuration, refrigeration circuit 18 is off, and therefore the fluid therein is neither refrigerated nor circulated.

In particular, valve assembly 36 comprises a second intermediate valve 58 situated downstream of cooling tract 34 and of cooling valve 50. Also, the second intermediate valve 58 is connected between interior heating tract 42 and operative tract 16, which are connected in parallel with each other. The second intermediate valve 58 is configured for controlling, in the cooling configuration, the flow of fluid coming from cooling tract 50 and directed towards interior heating tract 42 and operative tract 16. Preferably, in the cooling configuration the second intermediate valve 58 is a switching valve that selectively puts in communication cooling tract 34 and operative tract 16, preventing the flow of liquid through interior heating tract 42. Conversely, in the heating configuration, downstream of cooling valve 52, the second intermediate valve 58 selectively prevents the communication between cooling tract 34 and operative tract 16.

Of course, without prejudice to the principle of the invention, the forms of embodiment and the implementation details may be extensively varied from those described and illustrated herein by way of non-limiting example, without however departing from the scope of the invention as set out in the appended claims.

1. A system for controlling a temperature of at least one battery in a vehicle and for defrosting a radiator associated with the system; said system comprising:
at least one battery configured for outputting electric power;
a thermal regulation circuit configured for having a liquid pass through and comprising an operative tract thermal exchange relation with said battery, to control the temperature of the battery;
a refrigeration circuit configured for being passed through by a fluid that is subjectable to a refrigeration cycle in a non-reversible manner; said refrigeration circuit comprising a condenser and an evaporator, which are in thermal exchange relation with a heating tract and, respectively, a cooling tract of said thermal regulation circuit for thermally interacting with said liquid to flow through said operative tract;
a radiator in thermal exchange relation with a thermal stabilization tract E of said thermal regulation circuit; and
a valve assembly configured for taking a defrosting configuration, in which said valve assembly defines, in the thermal regulation circuit, a closed defrosting path for the liquid between said heating tract and said thermal stabilization tract, and
a heater, which is activatable to heat the liquid to flow through said closed defrosting path.

2. The system according to claim 1, wherein said heater is in thermal exchange relation with a defrosting tract of said thermal regulation circuit.

3. The system according to claim 2, wherein in said defrosting configuration said closed defrosting path for the liquid is defined between said heating tract, said defrosting tract and said thermal stabilization tract.

4. The system according to claim 1, wherein in said defrosting configuration the operative tract is excluded from said closed defrosting path.

5. The system according to claim 1, wherein in said defrosting configuration the cooling tract is excluded from said closed defrosting path.

6. The system according to claim 2, wherein said valve assembly comprises an intermediate switching valve situated downstream of the defrosting tract and upstream of the operative tract and of the thermal stabilization tract.

7. The system according to claim 6, wherein in the defrosting configuration of said valve assembly said intermediate valve directs the liquid flow from said defrosting tract to said thermal stabilization tract, preventing the liquid from passing through the operative tract.

8. The system according to claim 1, further comprising at least one pumping device configured to induce a forced circulation of said liquid through said closed defrosting path when said valve assembly is in the defrosting configuration.

9. The system according to claim 8, wherein said pumping device is situated in said heating tract.

10. The system according to claim 1, wherein, when said valve assembly is in the defrosting configuration, said refrigeration circuit is off.
